(19) United States
(12) Patent Application Publication
(10) Pub. No.: US 2012/0167680 A1
(43) Pub. Date: Jul. 5, 2012

(54) APPARATUS FOR DRIVING MULTI-AXIAL ANGULAR VELOCITY SENSOR

(75) Inventors: Byoung Won Hwang, Gyunggi-do (KR); Jung Won Lee, Seoul (KR); Byeung Leul Lee, Gyunggi-do (KR); Ho Seop Jeong, Gyunggi-do (KR)

(73) Assignee: SAMSUNG ELECTRO-MECHANICS CO., LTD., Gyunggi-do (KR)

(21) Appl. No.: 13/193,372

(22) Filed: Jul. 28, 2011

(30) Foreign Application Priority Data
Dec. 31, 2010 (KR) 1020100139977

(51) Int. Cl. G01C 19/56

(52) U.S. Cl. 73/504.12

(57) ABSTRACT

Disclosed herein is an apparatus for driving a multi-axial angular driving sensor. The apparatus includes a driving unit; a timing control unit outputting the start control signal to the driving unit, wherein the start control signal, when one axis is driven based on an axis drive stabilization section and a drive off section,; and a sensing unit. Therefore, the present invention can significantly improve the sampling time in a multi-axial sensor.

### CROSS REFERENCE TO RELATED APPLICATION

This application claims the benefit of Korean Patent Application No. 10-2010-0139977, filed on Dec. 31, 2010, entitled “Apparatus for Driving Multi-axial Angular Velocity Sensor” which is hereby incorporated by reference in its entirety into this application.

### BACKGROUND OF THE INVENTION

1. Technical Field

The present invention relates to an apparatus for driving a multi-axial angular velocity sensor.

2. Description of the Related Art

From the past, gyros have been known as an angular velocity sensor sensing an angular velocity. Among the gyros, specially, a gyro using a vibrator is referred to as a vibrating gyro, which is being widely used in a variety of uses, such as sensing the hand-shake in a video camera or a digital still camera, sensing the direction in a car navigation system, controlling the posture of a moving object in a vehicle, and the like.

This gyro measures the angular velocity by using a Coriolis force of a vibrating object.

The Coriolis force is expressed by the following Equation (1):

F=2mVΩ (1)

where, F is Coriolis force, m is mass, V is velocity, and Ω is angular velocity.

The angular velocity Ω due to this Coriolis force is expressed by Ω=2mV/F from the Equation (1). The angular velocity Ω may be obtained by measuring the Coriolis force F when a constant velocity V is applied to an object.

F, V, Ω are vectors having directions perpendicular to one another. For example, the angular velocity Ω in the z direction is obtained by applying the velocity V in the x direction and measuring the Coriolis force F in the y direction.

In addition, the angular velocity Ω in the x and y directions is obtained by applying the velocity V in the z direction and measuring the Coriolis force F in the y and x directions.

That is, a vibration direction of the vibrating object needs to be changed in order to measure the angular velocity in several directions.

Since the gyro generally vibrates an object having a high Q value, a great deal of stopping time is required due to vibration by an influence of inertia in order to measure the angular velocities in the x and y directions by driving in the z axis, and then measure the angular velocity in the z axis by driving in the x axis after changing the moving direction of the object.

### SUMMARY OF THE INVENTION

The present invention has been made in an effort to provide an apparatus for driving a multi-axial angular velocity sensor capable of minimizing the driving time at the time of direction change.

According to a preferred embodiment of the present invention, there is provided an apparatus for driving a multi-axial angular velocity sensor, the apparatus including: a driving unit driving a vibrator of an angular velocity sensor to vibrate based on a corresponding axis according to a start control signal; a timing control unit outputting the start control signal to the driving unit, wherein the start control signal, when one axis is driven based on an axis drive stabilization section and a drive off section, makes the axis be waiting during the axis drive stabilization section and then controls the other axis to start up during the drive off section of the corresponding axis; and a sensing unit sensing an output value outputted from the angular velocity sensor to generate and output an axial directional angular velocity signal.

The driving unit may include an oscillation circuit driving the vibrator of the angular velocity sensor to vibrate based on the corresponding axis according to the start control signal.

The timing control unit may output the start control signal for controlling the other axis to start up simultaneously with entering the drive off section.

The timing control unit may include: a drive stabilization section detector detecting and outputting whether or not the vibrator enters the drive stabilization section from an output signal of the angular velocity sensor; a drive off section entry detector detecting and outputting whether or not the vibrator enters the drive off section from the output signal of the angular velocity sensor; and a start control signal output device maintaining the same state during the drive stabilization section detected by the drive stabilization section detector after outputting the start control signal with respect to one axis, and generating and outputting the start control signal for driving the other axis during the drive off section detected by the drive off section entry detector.

The timing control unit may further include a driving order storage storing the driving order with respect to multiple axes, and the start control signal output device may output the start control signal for driving the vibrator of the angular velocity sensor according to the order of axis stored in the driving order storage.

The sensing unit may include: a differential circuit differentially amplifying a detection signal from the vibrator; a synchronous detection circuit detecting the signal differentially amplified by the differential circuit to output the detected signal as a detection signal; and a rectification circuit rectifying the detection signal outputted from the synchronous detection circuit to output the rectified signal as a detection voltage signal.

### BRIEF DESCRIPTION OF THE DRAWINGS

FIG. 1 is a configuration diagram of an apparatus for driving a multi-axial angular velocity sensor according to a preferred embodiment of the present invention;

FIG. 2 is a timing chart showing a procedure of generating a start drive signal by a timing control unit in FIG. 1;

FIG. 3 is an inside block diagram of the timing control unit in FIG. 1; and

FIG. 4 is an inside block diagram of a driving unit and a sensing unit in FIG. 1.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

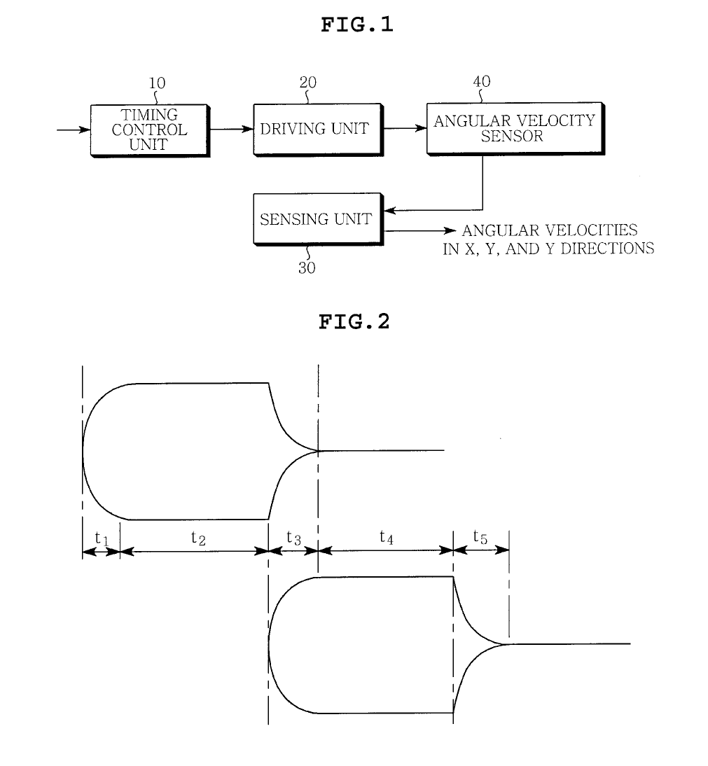

FIG. 1 is a configuration diagram of an apparatus for driving a multi-axial angular velocity sensor according to a preferred embodiment of the present invention.

Referring to FIG. 1, an apparatus for driving a multi-axial angular velocity sensor according to a preferred embodiment of the present invention includes a timing control unit 10, a driving unit 20, a sensing unit 30, and an angular velocity sensor 40.

The timing control unit 10 outputs start control signals. Each of the start control signals, when one axis is driven, on the basis of an axis start section, and an axis drive stabilization section and an axis drive off section, controls another axis to start up during the axis drive off section of the corresponding axis.

Preferably, the timing control unit 10 outputs a start control signal of controlling another axis to start up simultaneously with entering the drive off section.

For example, as shown in FIG. 2, the timing control unit 10 outputs a z-axis start control signal of performing z-axis driving by a driving signal to control the vibrator of the angular velocity sensor 40 to start up based on the z-axis by the driving unit 20.

Subsequently, the timing control unit 10 detects the drive stabilization section to maintain a waiting state during the drive stabilization section, and then, when detecting the entry to a z-axis drive off section, outputs an axis start control signal for x-axis driving of the angular velocity sensor 40 to the driving unit 20 to control the vibrator of the angular velocity sensor 40 to be driven based on the x-axis.

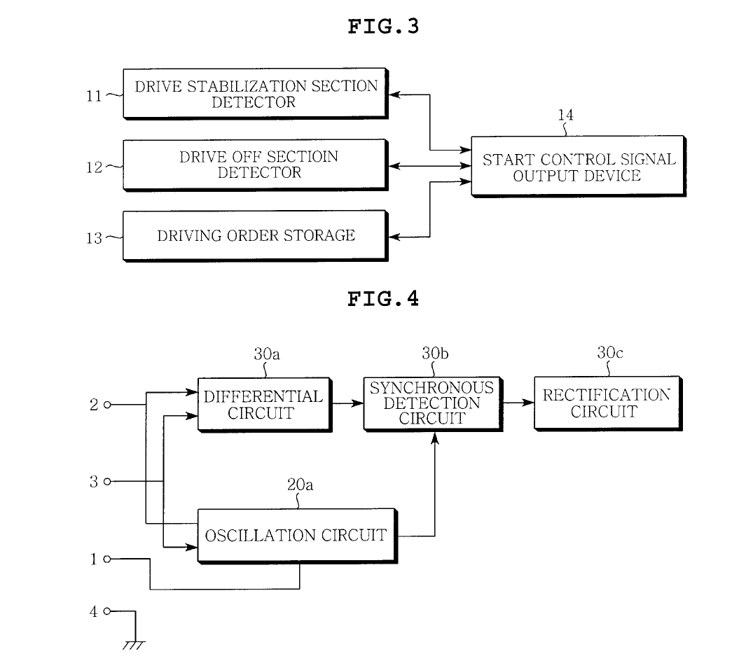

An example of the timing control unit 10 of performing this function is shown in FIG. 3. The timing control unit 10 includes a drive stabilization detector 11, a drive off section detector 12, a driving order storage 13, and a start control signal output device 14.

The drive stabilization section detector 11 detects and outputs whether or not the vibrator of the angular velocity sensor 40 enters the drive stabilization section with respect to the corresponding axis from an output of the angular velocity sensor 40 after the start control signal output device 14 outputs the start control signal.

The drive off section detector 12 detects and outputs whether or not the corresponding vibrator enters the drive off section from the output of the angular velocity sensor 40 after the angular velocity sensor 40 is driven during a predetermined time period.

Then, the driving order storage 13 stores the driving order with respect to multiple axes, and the driving order may be changed according to setting of a user.

Meanwhile, the start control signal output device 14 outputs the start control signal for driving the angular velocity sensor 40 in response to a drive request signal of the angular velocity sensor 40 according to the order in which start control signals are stored in the driving order storage 13.

Herein, the start control signal output device 14 maintains the same state during the drive stabilization section detected by the drive stabilization section detector 11 after the start control signal with respect to the initial axis is outputted according to the order in which the start control signals are stored in the storage 13, and generates and outputs the start control signal for driving the other axis according to the order during the drive off section detected from the drive off section detector 12.

As such, the sampling time in a single mass multi-axial sensor can be significantly improved by performing overlap driving when the start control signal output device 14 outputs the start control signal during the drive off section.

Due to this reduction of the sampling time, a measuring frequency bandwidth of the angular velocity sensor largely depending on the sampling time can be improved.

Next, the driving unit 20 drives the vibrator of the angular velocity sensor 40 based on the corresponding axis according to the start control signal outputted from the timing control unit 10.

The sensing unit 30 senses an output value generated and outputted from the angular velocity sensor 40 to generate and output an axis directional angular velocity signal.

FIG. 4 is a block diagram showing an example of the driving unit 20 and the sensing unit 30.

The driving unit 20 is constituted of an oscillation circuit 20a, and the sensing unit 30 includes a differential circuit 30a, a synchronous detection circuit 30b, and a rectification circuit 30c.

The vibrator is connected to terminals 1, 2, 3, and 4 of the driving unit 20 and the sensing unit 30.

As for the driving unit 20, the oscillation circuit 20a is connected to an electrode for detecting the vibrator, and connected to an electrode for driving the vibrator and the synchronous detection circuit 30b, and the oscillation circuit 20a constitutes a self oscillation circuit.

Due to this constitution, an oscillation signal from the oscillation circuit 20a is applied to the vibrator as a driving signal, thereby driving the vibrator.

The detection signal from the vibrator is applied to the differential circuit 30a, and then differentially amplified by the differential circuit 30a. The oscillation signal from the oscillation circuit 20a is applied to the synchronous detection circuit 30b as a signal for synchronous detection. The synchronous detection circuit 30b detects the differentially amplified signal in synchronization with the signal for synchronous detection, and outputs the differentially amplified signal as a detection signal. This detection signal is rectified by the rectification circuit 30c, and outputted from an output terminal as a detection voltage signal.

Meanwhile, the angular velocity sensor 40 is driven according to a drive signal of the driving unit 20 to calculate and output an angular velocity value.

There are several shapes such as a tuning fork shape, an H shape, a T shape, or a tuning bar shape, or the like, in the shape of this angular velocity sensor 40.

The angular velocity sensor 40 includes the vibrator, and Coriolis force (inertial force) is generated due to vibration and rotation of the vibrator. The sensing unit 30 senses the signal generated from the angular velocity sensor 40 by the Coriolis force to calculate and output an angular velocity of rotation of the angular velocity sensor 40.

As described above, the present invention can significantly improve the sampling time in a single mass multi-axial sensor by performing overlap driving.

Therefore, due to this reduction of the sampling time, the present invention can improve a measuring frequency bandwidth of the angular velocity sensor largely depending on the sampling time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An apparatus for driving a multi-axial angular velocity sensor, the apparatus comprising:
a driving unit driving a vibrator of an angular velocity sensor to vibrate based on a corresponding axis according to a start control signal;
a timing control unit outputting the start control signal to the driving unit, wherein the start control signal, when one axis is driven based on an axis drive stabilization section and a drive off section, makes the axis be waiting during the axis drive stabilization section and then controls the other axis to start up during the drive off section of the corresponding axis; and
a sensing unit sensing an output value outputted from the angular velocity sensor to generate and output an axial directional angular velocity signal.

2. The apparatus as set forth in claim 1, wherein the driving unit includes an oscillation circuit driving the vibrator of the angular velocity sensor to vibrate based on the corresponding axis according to the start control signal.

3. The apparatus as set forth in claim 1, wherein the timing control unit outputs the start control signal for controlling the other axis to start up simultaneously with entering the drive off section.

4. The apparatus as set forth in claim 1, wherein the timing control unit includes:
a drive stabilization section detector detecting and outputting whether or not the vibrator enters the drive stabilization section from an output signal of the angular velocity sensor;
a drive off section entry detector detecting and outputting whether or not the vibrator enters the drive off section from the output signal of the angular velocity sensor; and
a start control signal output device maintaining the same state during the drive stabilization section detected by the drive stabilization section detector after outputting the start control signal with respect to one axis, and generating and outputting the start control signal for driving the other axis during the drive off section detected by the drive off section entry detector.

5. The apparatus as set forth in claim 4, wherein the timing control unit further includes a driving order storage storing the driving order with respect to multiple axes, and the start control signal output device outputs the start control signal for driving the vibrator of the angular velocity sensor according to the order of axis stored in the driving order storage.

6. The apparatus as set forth in claim 1, wherein the sensing unit includes:
a differential circuit differentially amplifying a detection signal from the vibrator;
a synchronous detection circuit detecting the signal differentially amplified by the differential circuit to output the detected signal as a detection signal; and
a rectification circuit rectifying the detection signal outputted from the synchronous detection circuit to output the rectified signal as a detection voltage signal.
